(19) United States
(12) Patent Application Publication
(10) Pub. No.: US 2018/0266453 A1
(43) Pub. Date: Sep. 20, 2018

(54) Ready Glove

(71) Applicant: Melvin A. Hall, Saraland, AL (US)

(72) Inventor: Melvin A. Hall, Saraland, AL (US)

(21) Appl. No.: 15/460,392

(22) Filed: Mar. 16, 2017

(51) Int. Cl. F16B 1/00; F16B 45/04

(52) U.S. Cl. CPC F16B 1/00; F16B 2001/0028; F16B 2001/0035; F16B 45/04

(57) ABSTRACT

My device is a Velcro strip that is 10 inches long and 1 inch wide, with a 6 inch Velcro strip attached to the top and bottom of 10 inch Velcro strip in a vertical centered position. The primary 10 inch Velcro strip has a magnetic device attached to the back of said 10 inch primary Velcro strip. The Velcro strip is attached to the metal arm of a golf cart by placing back of primary strip containing magnetic device against the metal bar on golf cart and wrapping the smaller 6 inch strips around the bar of the golf cart. My device once attached to the cart will allow a golfer to attach their golf glove(s) to the 10 inch primary velcro strip allowing air to pass through the glove as the cart moves keeping the glove(s) dryer and ready for use. It will also allow the glove to last longer by reducing the amount of sweat that resides in the glove and allows the glove to perform as intended due to being dryer with the use of air passing through the glove.

Second description of different design,

My device is a 10 inch Velcro strip that is attached to a clip which is attached to a golf bag by opening the clip and placing the clip on a hook (which is part of the golf walking bag) and then releasing the clip. The golfer can attach their glove(s) to the 10 inch primary velcro strip and this will allow the air to pass through the glove(s) as the golfer walks, thereby creating the same effect of keeping golf glove ready for use by keeping dryer.

### CROSS-REFERENCE TO RELATED APPLICATIONS

No related applications.

### STATEMENT REGARDING FEDERALLY SPONSORED RESEARCH OR DEVELOPMENT

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

N/A

### STATEMENT REGARDING PRIOR DISCLOSURES BY THE INVENTOR OR A JOINT INVENTOR

N/A

### BACKGROUND OF THE INVENTION

### (1) Field of the Invention: Golf Accessories

### (2) Description of Related Art Including Information Disclosed Under 37 CFR 1.97 and 1.98

During the use of a golf glove, sweat from the arm and hand of the user will drain into the glove making it wet and unusable. When using a golf cart to play golf there is no place on a cart that is designed to hold a golf glove, thereby the user will have to keep the glove in a clothes pocket, which also will help the glove contain the sweat moisture. Also, many gloves are left in the golf cart after the round due to the fact that the glove may be placed into a pocket in the cart during use and not seen after completion of the round and end up lost.

### BRIEF SUMMARY OF THE INVENTION

My device allows one to attach a golf glove(s) to said device which then allows the golf glove to stay dry during use and makes the glove easier to use and more effective. By allowing air to pass through the glove using my device it stays dryer and useable.

### BRIEF DESCRIPTION OF THE SEVERAL VIEWS OF THE DRAWING(S)

FIG. 1 is a 6 inch long by 1 inch wide Velcro strip

FIG. 2 is a 10 inch long by 1 inch wide Velcro strip

FIG. 3 is a 10 inch long by 1 inch wide strip of magnetic tape

FIG. 4 is a 6 inch long by 1 inch wide Velcro strip

FIG. 5 shows how the 6×1 inch strips are attached to the FIG. 2 10 inch by 1 inch velcro strip

FIG. 6 is a 10 inch by 1 inch Velcro strip

FIG. 7 is a plastic clip

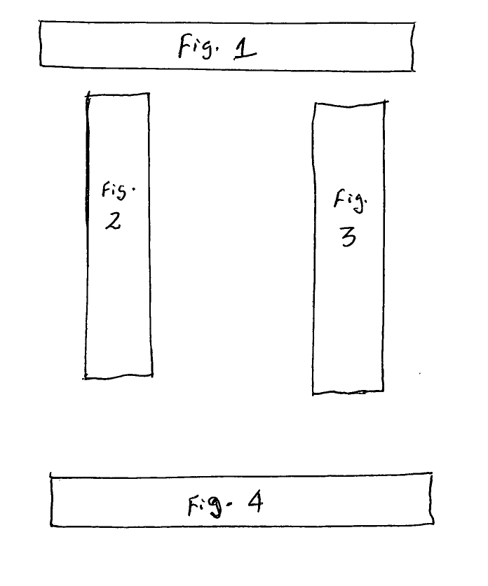

### DETAILED DESCRIPTION OF THE INVENTION

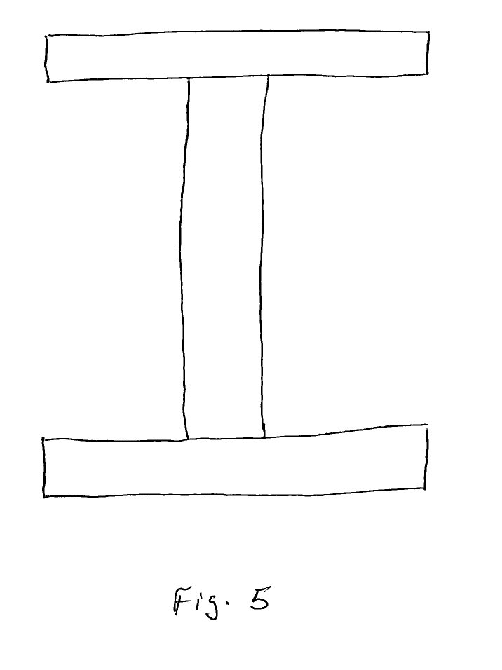

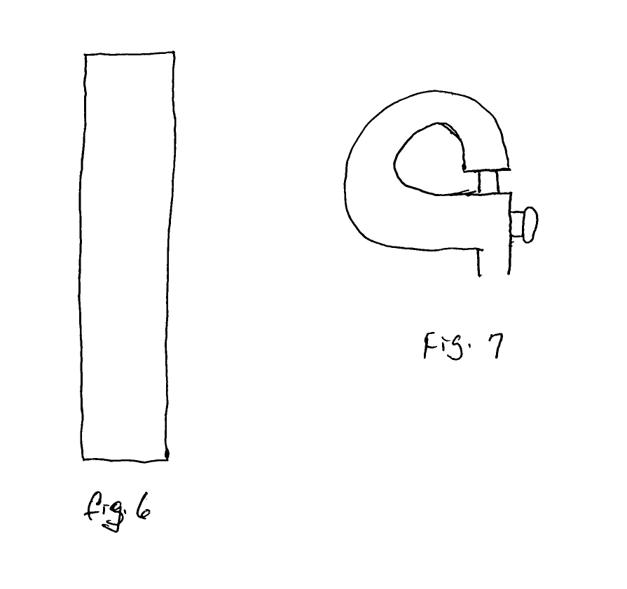

My device consist of a Velcro strip that is 10 inches in length and 1 inch wide, FIG. 2. Attached to the 10 inch strip are (2) 6 inch by 1 inch strips, FIG.(s) 1&4, that are attached to the top and bottom of 10 inch strip in a vertical position. See FIG. 5. also attached to the back of the 10 inch strip in FIG. 2 is a magnetic device of 1 inch wide magnetic tape, using an approximate length of 8 inches, see FIG. 3.

My device also consist of a device used for a walk bag. It consist of a 10 inch by 1 inch Velcro strip, FIG. 6 attached to a clip as seen in FIG. 7. The clip is attached to the walking bag and used in same manner.

1; compromising,
A primary Velcro strip with dimensions of 10 inches long and 1 inch wide, see FIG. 2
A smaller Velcro strip (quantity 2) with dimensions of 6 inch by 1 inch, see FIG.(s) 1&4, attached to the bottom and top of 10 inch Velcro strip in vertical position to said primary Velcro strip.
A magnetic device, see FIG. 3, attached to the back of said primary 10 inch Velcro strip.

2; compromising,
A primary Velcro strip with dimensions of 10 inch long and 1 inch wide, see FIG. 6
A clip, FIG. 7 that is attached to one end of said 10 inch Velcro strip.
